(19) United States
(12) Patent Application Publication
(10) Pub. No.: US 2018/0123422 A1
(43) Pub. Date: May 3, 2018

(54) ELECTRICAL MACHINE AND VEHICLE TRANSMISSION

(71) Applicant: ZF Friedrichshafen AG, Friedrichshafen (DE)

(72) Inventors: Stefan RENNER, Bodman-Ludwigshafen (DE); Rayk GERSTEN, Friedrichshafen (DE); Maximilian SCHEUFLER, Salem (DE); Gerhard HÖRING, Hagnau am Bodensee (DE); Jürgen RAUTER, Friedrichshafen (DE)

(21) Appl. No.: 15/801,483

(22) Filed: Nov. 2, 2017

(30) Foreign Application Priority Data
Nov. 3, 2016 (DE) 10 2016 221 572.8

(51) Int. Cl. H02K 7/00; H02K 7/116; H02K 9/00; H02K 5/04

(52) U.S. Cl. CPC H02K 7/006; H02K 5/04; H02K 9/005; H02K 7/116

(57) ABSTRACT

An electrical machine has a housing (2), a stator (3) arranged in the housing (2) in a rotationally fixed manner, and with a rotor (4) mounted so that the rotor (4) can rotate in the housing (2). A degree of freedom is provided, in the radial direction, between the housing (2) and the stator (3) so as to permit material-related thermal expansion differences between the housing (2) and the stator (3) in the radial direction. Throughout the operating range of temperatures encountered during use, the stator (3) is held in the housing (2) and is aligned concentrically with the rotor (4) by the interlocking connection elements (5). The interlocking connection elements (5) are designed and arranged in such manner that the housing (2) can expand and contract, in a stress-free manner, relative to the stator (3). In addition the electrical machine is arranged in a vehicle transmission.

This application claims priority from German patent application serial no. 10 2016 221 572.8 filed Nov. 3, 2016.

### FIELD OF THE INVENTION

The invention concerns an electrical machine with a housing, a stator arranged in a rotationally fixed manner in the housing and a rotor mounted so as to rotate in the housing. In addition the invention concerns a vehicle transmission with such an electrical machine.

### BACKGROUND OF THE INVENTION

An electrical machine of that type can be used for example as a drive machine in the drive-train of a vehicle. The drive-train of a vehicle is often exposed to a very wide operating temperature range, and during operation individual components are heated to even higher temperatures, so that an electrical machine used in the drive-train of a vehicle has to function, for example, in an operating temperature range of −40° C. to +150° C.

Usually the stator of the electrical machine and its lamination pack is made of steel or a steel alloy, whereas the housing of an electrical machine is as a rule made of some other material, for example cast aluminum, i.e. an aluminum alloy. For a fixed connection between the housing and the stator, the latter is often press-fitted into the substantially cylindrical housing and/or bolted thereto. In some cases an additional stator carrier is also provided for this.

Due to the above-described large temperature differences in the electrical machine and its different materials, there are considerably different thermal expansions between the stator and the housing of the electrical machine. These differences may be large enough for a press fit between the housing and the stator to become ineffective, for components to be plastically deformed and/or for the concentric alignment between the stator and the rotor of the electrical machine to be no longer guaranteed. In the case of a bolted-on stator large temperature variations can result in movements between the components, wear at the bolting points and excessive component loading due to stresses.

To avoid such drawbacks, in DE 8137239 U1 it is proposed to secure an interlocking press-fit connection between a stator and a housing sleeve against breaking loose and twisting of the stator in the housing sleeve by means of an additional interlocking spring that engages in a groove in the stator or the housing sleeve. In this solution the housing sleeve and the stator are under permanent stress by virtue of the press fit, and due to the temperature differences and consequent thermal expansion differences in the housing sleeve and the stator, alternating stresses occur which can lead to loosening of the rotationally fixed connection between the housing sleeve and the stator, and/or to damage of the components.

Furthermore, DE 202008015575 U1 describes an electric motor in which a motor housing with the stator engages with a separate centering arrangement in such manner that particularly in the case of temperature-related play between the motor housing, on the one hand, and the stator, on the other hand, the concentric alignment between the stator and the rotor is ensured. The centering arrangement consists essentially of a plurality of springs positioned between the motor housing and the stator, which produce a pre-stress on the stator and restrict the freedom of movement between the stator and the motor housing. This too can produce undesired stresses in the components.

### SUMMARY OF THE INVENTION

The purpose of the present invention is to provide an electrical machine of the type mentioned to begin with, in which temperature-related different expansion behaviors of the stator and the housing is possible while producing the lowest possible stresses, and wherein at the same time the concentric alignment between the stator and the rotor of the electrical machine is ensured. The electrical machine should be as compact as possible and of simple design. Furthermore, a vehicle transmission with such an electrical machine should be provided.

The objective on which the invention is based is achieved by an electrical machine and by a vehicle transmission according to the claims. Advantageous further developments of the invention are indicated in the dependent claims.

According to these, an electrical machine with a housing, a stator arranged rotationally fixed in the housing and with a rotor mounted to rotate in the housing is claimed. In this case a degree of freedom in the radial direction is provided between the housing and the stator, in order to permit material-related thermal expansion differences between the housing and the stator in the radial direction, so that by means of interlocking connection elements the stator is held in the housing throughout the temperature range encountered during use and is kept aligned concentrically with the rotor. The interlocking connection elements are designed and arranged in such manner that relative to the stator the housing can expand and contract without stress. In other words, stress-free radial expansion and shrinking of both the components, housing and stator, relative to one another, brought about by temperature changes, is possible without affecting the centering of the stator in the housing or the torque transmission. Reducing the stresses in the components prolongs their useful life.

The degree of freedom in the radial direction enables this thermal expansion compensation, while at the same time the connection elements prevent loose play between the stator and the housing. No separate stator carrier between the stator and the housing is needed, since with the help of the connection elements the stator is connected directly to the housing or suspended in the housing.

With an intelligent geometrical arrangement of at least three connection elements in the area of the outer circumference of the stator, it can therefore be ensured that, relative to the housing, the stator is not twisted and not displaced in relation to the central axis of the electrical machine. This means that there is no appreciable play between the housing and the stator either in the radial, or in the tangential direction. The stator is held rotationally fixed and centered in the housing only by the connection elements. Since the rotor too is mounted in the housing, the concentricity between the rotor and stator required for the correct functioning of the electrical machine can be ensured in that way. At the same time the housing and the stator can expand and contract to different extents in an essentially play-free and stress-free manner, so that no stresses are produced in any of the components, particularly none caused by the different thermal expansions of the housing and the stator. Accordingly, in the solution proposed neither are any spring forces and pre-stresses required for centering. The connection elements, described in greater detail below, can move relative to one another freely, i.e. without pre-stressing. It is this to which the core concept of the present invention corresponds, namely to avoid any play between the housing and the stator of the electrical machine whereas the different thermal expansions of the housing and the stator are enabled without constraining forces and without stresses.

In this document, unless otherwise indicated expressly, the terms axial, radial and tangential relate to the main axis of the electrical machine, which corresponds to the rotational axis of the rotor.

The connection elements preferably comprise at least three bolts, and in each case a recess in the stator or the housing is associated with each of the bolts. Particularly preferably, the bolts are firmly connected to the housing, for example press-fitted or screwed into the housing, and the recesses, one of which is associated with each bolt, are formed in the stator. Thus, each bolt can move freely in its associated recess in the radial direction without pre-stressing.

For this purpose the recesses are preferably in the form of elongated grooves or slots that extend in the radial direction. With specified or known materials and dimensions for the housing and the stator, the necessary sizes of the bolts and recesses, in this case particularly the required lengths of the elongated grooves or slots in the radial direction, can be calculated selectively in such manner that, relative to the stator, the housing can expand and contract without stress throughout the range of temperatures encountered during use.

The use of bolts, especially solid bolts, enables the invention to be used even in large electrical machines in which high drive torques have to be supported, for example in the drive-trains of vehicles. Typically the outer diameter of the stator of such an electrical machine amounts to 400 to 500 millimeters. Lighter connection elements, which could for example also serve as springs and are made from sheet metal, are not suitable for such applications because under high torques and forces they deform plastically and would fail. This applies particularly when the electrical machine is intended to operate as a motor and as a generator, whereby alternating stresses in the tangential direction act upon the connection elements.

In advantageous designs more than three, for example six bolts and recesses are provided. In this way a production-technology-related minimum play between the bolts and the recesses associated therewith in the tangential direction, i.e. in the circumferential direction, can be minimized and reduced to zero in the ideal case, because if there are a plurality of bolts and recesses around the circumference of the stator, the requisite manufacturing tolerance between the external dimensions of the bolts and the internal dimensions of the recesses is distributed and compensated by pitch errors. For example the manufacturing tolerance or play between the external dimensions of the bolts and the internal dimensions of the recesses can range between 0.05 and 0.2 millimeters. In this context pitch errors are understood to mean angular deviations in the distribution of the at least three bolts and recesses around the circumference of the housing or the stator. For example, three bolts and recesses are advantageously arranged in each case 120° apart around the circumference of the housing or stator. With six bolt-recess pairs the most advantageous uniform angle between two adjacent bolts or recesses is in each case 60°. This means that at each individual pairing of a bolt with its associated recess a certain play in the tangential direction can be present, but when all the bolt-recess pairs arranged around the stator are considered together this play is at least almost eliminated. During the assembly of the electrical machine an appropriate stator can be pushed freely onto the bolts fixed to the housing, or at least using only a slight force in the axial direction.

If despite the pitch errors described between the ready-assembled stator and the housing a minimal play in the tangential direction remains, a stable angular position of the stator and the housing relative to one another and the concentric alignment between the stator and the rotor are still obtained due to the tangential forces on the connection elements produced by the drive torque of the electrical machine during operation.

According to a preferred embodiment it is provided that at least over part of their axial length the bolts have a circular cross-section. Particularly preferably, the bolts can be cylindrical over their entire axial length. A circular cross-section, i.e. a cylindrical bolt, can, on the one hand, be produced simply and cheaply and, on the other hand, it can be fixed into a hole in the housing simply, for example press-fitted therein.

In a simple design, the part of the bolt projecting into the associated recess can have a circular cross-section, so that there is linear contact between the cylindrical sleeve-shaped outer surface of the bolt and a flat inside surface of the associated recess. However, in other designs the bolts, in the area of the recesses, can have flattened areas of the bolt outer surface so that there is a flat surface-to-surface contact area between the outer surface of the bolt and the flat inside surface of the recess. In this way the Hertzian pressure on the contact surface is reduced and plastic deformations in that area are avoided. With the same objective, the outer surface of the bolt and/or the inner surface of the associated recess can be specially hardened, or provided with reinforcement.

As already described above, the rotor is mounted so that it can rotate in the housing. This description includes designs in which the rotor is fitted directly in the housing, i.e. in which the housing therefore forms a bearing seat for the rotor or comprises a rotor bearing. In addition, however, the description also includes designs in which a bearing support is fitted into the housing. Such a bearing support can for example be made as a separate component and screwed or press-fitted into the housing. Such a bearing support can also be made as part of the housing and, for example, be in the form of a bearing cover which covers or closes off an axial end of the housing.

To ensure that heat is sufficiently conducted away from the components of the electrical machine, an intermediate space can be left as a cooling chamber between an inside surface of the housing and an outer surface of the stator, the space being filled at least partially with a coolant. To allow the temperature-related different expansions between the housing and the stator according to the invention, an intermediate space between the inside surface of the housing and the outer surface of the stator is needed anyway. Using this intermediate space as a cooling chamber gives the space an additional function. Advantageously, during operation the coolant is distributed all over the inside space of the electrical machine, in particular due to the movement of the rotor, so that effective and sufficient cooling of all the components takes place. A suitable shape of the contours in the inside space can advantageously spread the coolant or a coolant mist in and throughout the intermediate space, in particular in order to cool the housing and the stator effectively. In this respect the design of the connection elements as bolts and elongated holes or slots is advantageous, since between such elements more space is left free, through which the coolant can be passed into the cooling chamber.

Finally, the present invention includes a vehicle transmission with a transmission housing and with an electrical machine as described above, wherein the transmission housing is at the same time the housing of the electrical machine. In otherwords the electrical machine can be integrated in a vehicle transmission and according to the invention the stator of the electrical machine is fixed inside the transmission housing by means of the connection elements, so that relative to the stator the transmission housing can expand and contract without stress when temperature changes occur, throughout the range of temperatures encountered during use.

### BRIEF DESCRIPTION OF THE DRAWINGS

Below, the invention and its advantages are explained in more detail with reference to an example embodiment illustrated in the figures, which show:

FIG. 1: A section through an electrical machine, viewed in the axial direction,

FIG. 2: A section through an electrical machine, viewed in the radial direction from the side, and

FIG. 3: A schematic diagram showing the forces that act upon the connection elements between the stator and the housing during operation.

### DETAILED DESCRIPTION OF THE PREFERRED EMBODIMENTS

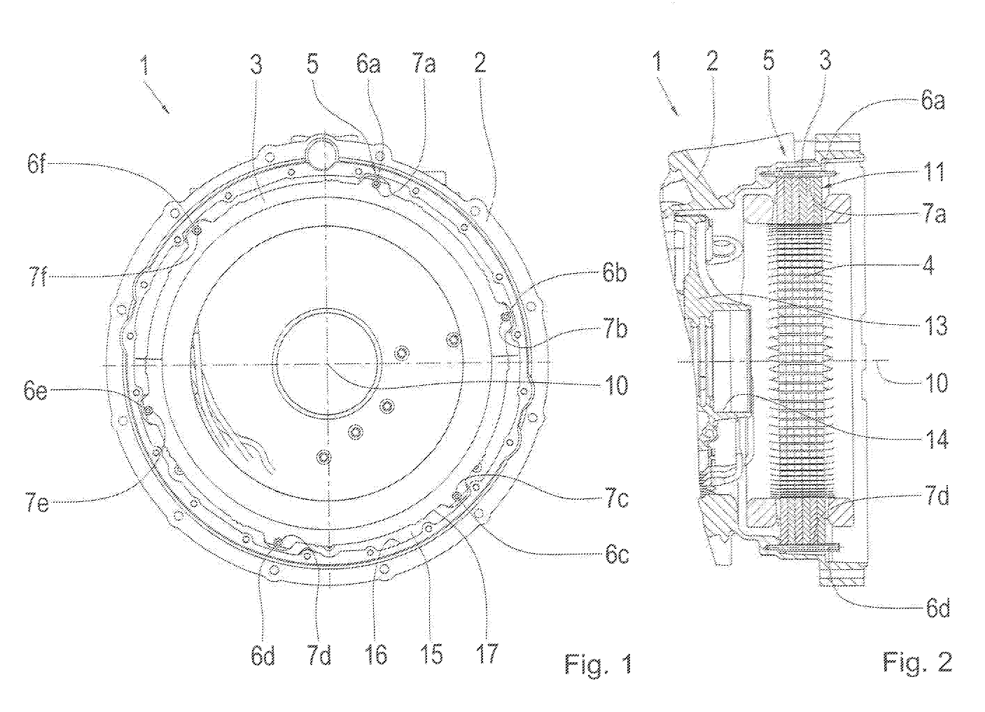

FIGS. 1 and 2 show one and the same example embodiment in two different section planes. Accordingly, in what follows the example embodiment will be explained conjointly with reference to FIGS. 1 and 2. The same components are given the same indexes. The essential components of the electrical machine 1, namely the housing 2, the stator 3 and the rotor 4, are arranged essentially concentrically about the main axis 10 of the electrical machine.

The housing 2 encloses the rest of the electrical machine 1 around its entire circumference. It protects all the components arranged in the housing 2 against damaging environmental influences and serves as a container for cooling and lubricating fluid. The stator 3 is arranged rotationally fixed in the housing 2. The rotor 4 is mounted in the housing 2 in such manner that it can rotate. In this example embodiment the electrical machine 1 forms part of a vehicle transmission. Thus, the housing 2 of the electrical machine 1 is at the same time part of the transmission housing of the vehicle transmission. In this case the housing is cast from an aluminum casting alloy, whereas the stator 3 consists essentially of steel and steel alloys. The central element of the stator 3 is the stator lamination pack 11 which can be seen in FIG. 2, which consists of a steel alloy. The aluminum casting alloy of the housing 2 has a substantially larger linear expansion coefficient than the steel alloy of the stator 3. Thus, as the temperature increases the housing 2 expands substantially more and as the temperature falls it contracts substantially more than the stator 3. If the stator 3 were now fixed solidly in the housing 2, there would be a risk that at high temperatures the stator 3 would become detached from the housing 2. On the other hand, at low temperatures stresses could occur in the housing 2 which were high enough to damage the housing 2 permanently. Both of these adverse situations are reliably prevented by the present invention.

Between the housing 2 and the stator 3 a degree of freedom in the radial direction is provided, in order to permit different thermal expansions in the radial direction between the housing 2 and the stator 3. For this purpose the stator 3 is held in a rotationally fixed manner in the housing 2 by means of interlocking connection elements 5, i.e. the connection elements prevent the stator 3 from twisting relative to the housing 2 in relation to a main axis 10 of the electrical machine 1. Furthermore, together with a rotor bearing in the housing 2 the interlocking connection elements 5 ensure that throughout the range of temperatures encountered during use the stator 3 is aligned concentrically with the rotor 4. According to the invention, the interlocking connection elements 5 are designed and arranged in such manner that relative to the stator 3 the housing 2 can expand and contract in a stress-free manner.

In the present example embodiment the connection elements 5 consist of six bolts 6a, 6b, 6c, 6d, 6e, 6f and, associated respectively with each bolt, a recess 7a, 7b, 7c, 7d, 7e, 7f in the stator 3 or in the housing 2. The six bolts 6a, 6b, 6c, 6d, 6e, 6f are fixed in the housing 2 and the recesses 7a, 7b, 7c, 7d, 7e, 7f are in the form of radially directed elongated grooves in the stator 3. The six bolts 6a, 6b, 6c, 6d, 6e, 6f are arranged distributed uniformly around the inside circumference of the housing 2, i.e. offset by an angle of 60° from one another. Correspondingly, the respectively associated recesses 7a, 7b, 7c, 7d, 7e, 7f are distributed uniformly around the outer circumference of the stator 3. The bolts 6a, 6b, 6c, 6d, 6e, 6f are cylindrical and are fixed at both ends into the housing 2, whereas a central part of the bolts 6a, 6b, 6c, 6d, 6e, 6f extends in each case through the respectively associated recess 7a, 7b, 7c, 7d, 7e, 7f and is supported against the inside surface thereof.

The depth of the elongated grooves 7a, 7b, 7c, 7d, 7e, 7f is calculated and measured in such manner that throughout the temperature range encountered while the electrical machine 1 is in use, the stator 3 is held securely in the housing 2 and centered therein. If the temperature of the components increases the housing 2 can now expand more than the stator 3, whereby the bolts 6a, 6b, 6c, 6d, 6e, 6f fixed in the housing 2 can move radially outward in the elongated grooves of the stator 3. During this the stator 3 is held continuously and moreover still rotationally fixed in the housing 2. If the temperature falls, the housing contracts more than the stator 3 and the bolts 6a, 6b, 6c, 6d, 6e, 6f fixed in the housing 2 move radially inward in the elongated grooves or recesses 7a, 7b, 7c, 7d, 7e, 7f of the stator 3. The movements described between the interlocking connection elements 5 are not opposed by any forces apart from possible minimal friction forces, so that no stresses are produced in the components due to thermal expansion differences.

In this example embodiment the rotor 4 is fitted into a bearing seat 14, which is in turn arranged in a bearing support 13 fixed in the housing 2. In the present example the bearing support 13 and the housing 2 are made as separate components and then joined to one another with interlock. However, the bearing support 13 can also be made as part of the housing 2. For example, the bearing support 13 and the housing 2 can be made integrally as one casting. This does away with further manufacturing tolerances due to additional fixing points between the bearing support 13 and the housing 2, and makes it easier to align the rotor 4 concentrically relative to the housing 2 and ultimately also relative to the stator 3.

An intermediate space between a housing inside surface 16 and a stator outer surface 17 is designed to be a cooling chamber 15. During the operation of the electrical machine 1 this cooling chamber 15 is at least partially filled with coolant or a mist of coolant. This assists the dissipation of heat, i.e. the cooling of the stator 3 and the housing 2 in particular.

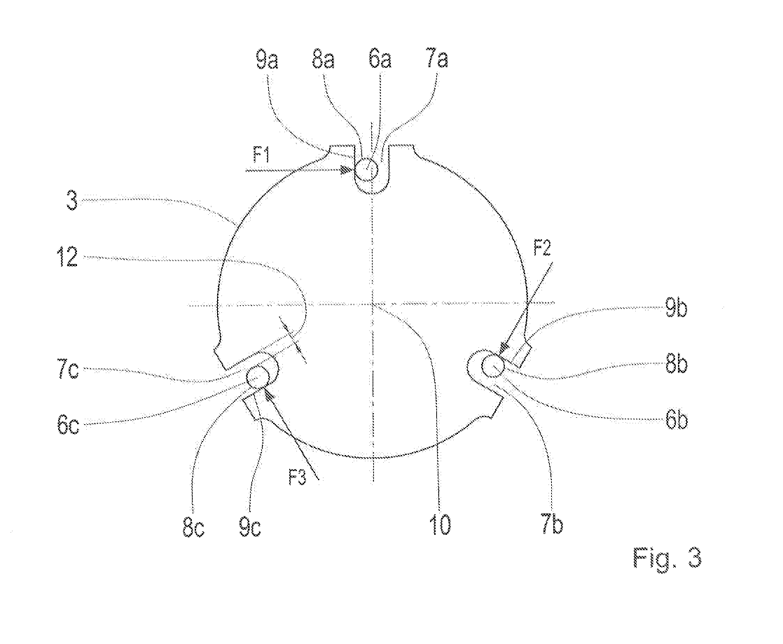

FIG. 3 shows in a very simplified manner the outer contour of the stator 3 of another example embodiment of the invention. In this case only three bolts 6a, 6b, 6c and recesses 7a, 7b, 7c are arranged as connection elements 5 between the housing (not shown here) and the stator 3. In this representation a play 12 attributable to manufacturing tolerances, in the tangential direction, i.e. in the circumferential direction between the bolts 6a, 6b, 6c and the respectively associated recesses 7a, 7b, 7c, is shown in very exaggerated form. In practice, however, as described earlier this play 12 can be minimized by pitch errors between the individual bolts 6a, 6b, 6c and recesses 7a, 7b, 7c, and in the ideal case reduced to zero. Sometimes the play 12 occurs between a bolt outer surface 8a, 8b, 8c and an inside surface 9a, 9b, 9c of the respectively associated recess 7a, 7b, 7c.

The forces F1, F2 and F3 indicated in FIG. 3 act in the tangential direction during the operation of the electrical machine 1 in each case between a bolt outer surface 8a, 8b, 8c and an inside surface 9a, 9b, 9c of the respectively associated recess 7a, 7b, 7c. The rotational direction in which the tangential forces F1, F2 and F3 act depends on whether the electrical machine 1 is being operated as a motor or a generator. However, regardless of which of these two modes the electrical machine 1 is being operated, in this area three equally sized forces F1, F2 and F3 are produced, which taken together can be represented as a closed triangle of forces. In a case in which the electrical machine 1 is at rest but there is still a minimal play between the housing 2 and the stator 3, the result of these forces is that the stator 3 is still centered in the housing 2, whereby the concentric alignment between the rotor 4 and the stator 3 is ensured.

Indexes

| | |
|---|---|
| 1 | Electrical machine |
| 2 | Housing |
| 3 | Stator |
| 4 | Rotor |
| 5 | Connection element |
| 6a, 6b, 6c, 6d, 6e, 6f | Bolts |
| 7a, 7b, 7c, 7d, 7e, 7f | Recesses |
| 8a, 8b, 8c | Outer surface of bolts |
| 9a, 9b, 9c | Inner surface |
| 11 | Stator lamination pack |
| 12 | Play |
| 13 | Bearing support |
| 14 | Bearing seat |
| 15 | Cooling chamber |
| 16 | Inside surface of the housing |
| 17 | Outer surface of the stator |

1-10. (canceled)

11. An electrical machine (1) comprising:
a housing (2),
a stator (3) being arranged in a rotationally fixed manner in the housing (2),
a rotor (4) mounted to rotate in the housing (2),
a degree of freedom, in a radial direction, being provided between the housing (2) and the stator (3) to permit material-related different thermal expansion, in the radial direction between the housing (2) and the stator (3),
the stator (3) being held in the housing (2) and aligned concentrically with the rotor (4) by interlocking connection elements (5) throughout a temperature range encountered during use, and
the interlocking connection elements (5) being formed and arranged such that the housing (2) can expand and contract, relative to the stator (3), in a stress-free manner.

12. The electrical machine according to claim 11, wherein the connection elements (5) comprise at least three bolts (6a, 6b, 6c) and a respective recess (7a, 7b, 7c) in either the stator (3) or in the housing (2) associated with each of the at least three bolts (6a, 6b, 6c).

13. The electrical machine according to claim 12, wherein the at least three bolts (6a, 6b, 6c) are each fixed in the housing (2) and the recesses (7a, 7b, 7c) are arranged in the stator (3).

14. The electrical machine according to claim 12, wherein the recesses (7a, 7b, 7c) are in a form of elongated grooves or slots that extend in the radial direction.

15. The electrical machine according to claim 12, wherein the bolts (6a, 6b, 6c) have a circular cross-section over at least part of an axial length thereof.

16. The electrical machine according to claim 15, wherein the bolts (6a, 6b, 6c) have a cylindrical shape over an entire axial length thereof.

17. The electrical machine according to claim 15, wherein the bolts (6a, 6b, 6c) have flat areas on an outer surface (8a, 8b, 8c) of each bolt, in an area of the recesses (7a, 7b, 7c), such that surface-to-surface contact exists between the outer surface (8a, 8b, 8c) of the bolt and an inner surface (9a, 9b, 9c) of the recess (7a, 7b, 7c).

18. The electrical machine according to claim 11, wherein the rotor (4) is mounted in the housing (2) by a bearing support (13).

19. The electrical machine according to claim 11, wherein an intermediate space, between an inner surface (16) of the housing (2) and an outer surface (17) of the stator (3), is designed as a cooling chamber (15) which is at least partially filled with a coolant.

20. A vehicle transmission with a transmission housing and with an electrical machine (1) comprising:
an electrical machine housing (2),
a stator (3) being arranged in a rotationally fixed manner in the electrical machine housing (2),
a rotor (4) being rotatably mounted in the electrical machine housing (2),
a degree of freedom, in a radial direction, being provided between the electrical machine housing (2) and the stator (3) to permit material-related different thermal expansions, in the radial direction, between the electrical machine housing (2) and the stator (3), and
the stator (3) being held in the electrical machine housing (2) and aligned concentrically with the rotor (4), throughout a temperature range encountered during use, by interlocking connection elements (5),
the interlocking connection elements (5) being formed and arranged such that, relative to the stator (3), the electrical machine housing (2) can expand and contract in a stress-free manner, and
the transmission housing also being, at the same time, the electrical machine housing (2).

21. An electrical machine comprising:
a housing,
a stator being arranged in a rotationally fixed manner within the housing;
a rotor being mounted to the housing to rotate about a main axis of the electrical motor;
a plurality of interlocking connection elements connecting the stator to the housing such that the stator being rotationally fixed relative to the housing,
the plurality of interlocking connection elements being formed and arranged to provide a degree of freedom, in a radial direction between the housing and the stator to facilitate, throughout a temperature range encountered during operation of the electric machine, and
material-related different thermal expansions, in the radial direction between the housing and the stator, retaining the stator within the housing aligned concentrically with the rotor such that the housing can expand and contract, relative to the stator, in a stress-free manner.

22. The electrical machine according to claim 21, wherein the plurality of interlocking connection elements comprise at least three bolts which are fixed in the housing, and the stator comprises at least three recesses, and each of the at least three bolts is aligned with a respective one of the at least three recesses.

23. The electrical machine according to claim 22, wherein the at least three recesses comprise radially directed elongated grooves in the stator.
